(19) United States
(12) Patent Application Publication
(10) Pub. No.: US 2014/0207575 A1
(43) Pub. Date: Jul. 24, 2014

(54) ELECTRONIC COMMERCE NETWORK USING MOBILE DEVICES

(71) Applicant: Index Systems, Inc., San Francisco, CA (US)

(72) Inventors: Marc FREED-FINNEGAN, San Francisco, CA (US); Ted TOMLINSON, Oakland, CA (US); Jonathan WALL, San Francisco, CA (US)

(73) Assignee: Index Systems, Inc., San Francisco, CA (US)

(21) Appl. No.: 14/161,620

(22) Filed: Jan. 22, 2014

Related U.S. Application Data
(60) Provisional application No. 61/755,135, filed on Jan. 22, 2013.

(51) Int. Cl. G06Q 30/06; G06Q 30/02; G06F 9/44

(52) U.S. Cl. CPC G06Q 30/0641; G06F 8/34; G06Q 30/0261
USPC 705/14.58; 705/27.1

(57) ABSTRACT

A mobile software development kit (“SDK”) executes on a mobile device that interfaces with a commerce network. The mobile SDK includes an interface to a host application on the commerce network, and an interface to a merchant application executing on the mobile device. The mobile SDK receives from the host application a check-in of the mobile device to a merchant, and an availability of new user objects, and provides the check-in and new user objects to the merchant application.

### CROSS REFERENCE TO RELATED APPLICATIONS

This application claims priority of Provisional Patent Application Ser. No. 61/755,135, filed on Jan. 22, 2013, the contents of which is hereby incorporated by reference.

### FIELD

One embodiment is directed generally to a computer system, and in particular to an electronic commerce network and system.

### BACKGROUND INFORMATION

Electronic commerce, or “e-commerce”, is generally considered the buying and selling of a product or service over electronic systems or a “commerce network” such as the Internet and other computer networks. Electronic commerce can include functionality such as mobile commerce, electronic funds transfer, supply chain management, Internet marketing, online transaction processing, electronic data interchange (“EDI”), inventory management systems, and automated data collection systems. Electronic commerce and a commerce network as a core function provides the exchange of data to facilitate the financing and payment aspects of business transactions.

The mobile commerce aspect of a commerce network, also referred to as mobile transactions, mobile payment, and mobile wallet, generally refers to payment services operated under financial regulation and performed from or via a mobile device such as a smartphone. Instead of paying with cash, check, or credit cards, a user can use a mobile phone to pay for a wide range of services and digital or hard goods.

There are many known models that can be used for mobile commerce. These models include Short Message Service (“SMS”) based transactional payments in which the user sends a payment request via an SMS text message and a premium charge is applied to the user's phone bill or online wallet. Another model is direct mobile billing in which the user uses the mobile billing option during checkout at an e-commerce site, such as an online gaming site, to make a payment. After authentication typically involving a personal identification number (“PIN”) and a password, the consumer's mobile account is charged for the purchase.

Another known model is mobile web payments in which the user uses web pages displayed or additional applications downloaded and installed on the mobile phone to make a payment using Wireless Application Protocol (“WAP”). Still another model is contactless Near Field Communication (“NFC”) in which a consumer using a special mobile phone equipped with a smart card waves the phone near a reader module. Most NFC transactions do not require authentication, but some require authentication using a PIN before the transaction is completed. The payment is deducted from a pre-paid account or charged to a mobile or bank account directly.

Each of these known models, and other known mobile commerce models, have potential disadvantages, including security concerns, lack of flexibility in that the user may be locked into a specific vendor or financial institution, and being difficult to use, especially when multiple or alternative forms of tender are involved in a transaction. As a result, no single model predominates the mobile commerce marketplace.

### SUMMARY

One embodiment is a mobile software development kit (“SDK”) that executes on a mobile device that interfaces with a commerce network. The mobile SDK includes an interface to a host application on the commerce network, and an interface to a merchant application executing on the mobile device. The mobile SDK receives from the host application a check-in of the mobile device to a merchant, and an availability of new user objects, and provides the check-in and new user objects to the merchant application.

### BRIEF DESCRIPTION OF THE DRAWINGS

Further details, advantages, and modifications will become apparent from the following detailed description of embodiments of the invention, which is to be taken in conjunction with the accompanying drawings, in which like numerals denote like elements.

FIG. 1 is an overview diagram of an electronic commerce network and associated peripheral devices in accordance with embodiments of the present invention.

FIG. 2 is a block diagram of a computer server/system that can implement the network of FIG. 1, and well as any of the associated peripheral devices of FIG. 1, in accordance with an embodiment of the present invention.

FIG. 3 is an overview diagram illustrating a user initiating the functionality of the network of FIG. 1 in accordance with one embodiment.

FIG. 4 is an overview diagram illustrating a merchant initiating the functionality of the network of FIG. 1 in accordance with one embodiment.

FIG. 5 illustrates a user being checked into a store with a store account in accordance with one embodiment.

FIG. 6 illustrates a POS client at the merchant and using the merchant account to checkout the user in accordance with one embodiment.

FIG. 7 further illustrates the checkout process based on a basket of goods selected by the user in accordance with one embodiment.

FIG. 8 illustrates the functionality of a transaction engine in accordance with an embodiment of the present invention.

FIG. 9 illustrates the functionality of the transaction engine with multiple items and multiple payment/tender options in accordance with an embodiment of the present invention.

FIG. 10 is a flow diagram of the functionality of the commerce network module of FIG. 1 when providing mobile commerce and conducting a mobile transaction in accordance with one embodiment.

FIG. 11 is a block diagram illustrating a mobile SDK within a mobile phone operating system in accordance with one embodiment of the invention.

FIG. 12 is a flow diagram of the functionality of the mobile SDK 1100 of FIG. 11 when providing mobile commerce and conducting mobile transactions in accordance with one embodiment.

FIG. 13 is a block diagram of a POS in accordance with one embodiment.

FIG. 14 is a block diagram of a POS in accordance with one embodiment that incorporates shadow integration when a beanstalk library/SDK cannot be directly integrated into POS SW.

### DETAILED DESCRIPTION

One embodiment is an electronic commerce network that facilitates mobile transactions. The commerce network allows a user with a mobile device to enter a store, and make a purchase of a basket of goods. The purchase can be made using one or more different tender instruments, including electronic coupons, gift certificates, debit cards, credit cards, etc. The commerce network authenticates the user, and can determine the best mix of tender instruments to use for the particular basket of goods.

The mobile device in one embodiment includes a mobile software development kit (“SDK”). The mobile SDK in one embodiment provides a number of features, such as geo-location based check-in, the transmission of data between the user, retailer and the commerce network (e.g., incentives, baskets of goods and payment credentials), the connecting of online and offline user actions, and real-time incentive delivery, activation and redemption.

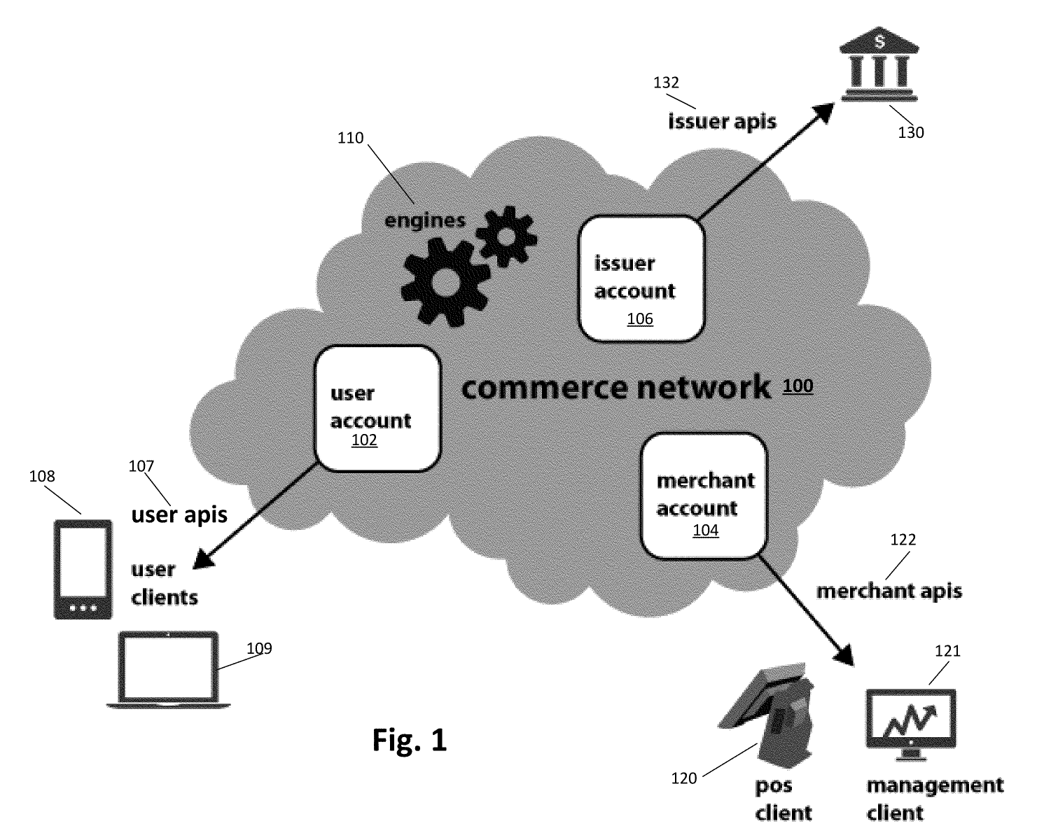

FIG. 1 is an overview diagram of an electronic commerce network 100 and associated peripheral devices in accordance with embodiments of the present invention. Network 100 is implemented by one or more server computers (“servers”) and is connected to the peripheral devices via the Internet, or other telecommunication means, to provide the functionality disclosed in detail below. Network 100 includes and implements at least one user/customer account 102, at least one merchant/retailer account 104 and at least one issuer account 106. Network 100 further includes one or more engines 110, including a transaction engine and a business optimization engine, as described in more detail below. The functionality of network 100 in one embodiment is accessible by any user over the Internet using a browser or any other interface method. The interface method can include application programming interfaces (“API”s) 107, 122 and 132.

Network 100 functions as a fabric that connects accounts for the principal parties of commerce—users, merchants, and issuers of tender. Network 100 enables fluid commerce by making accounts online and accessible. These accounts can be joined to facilitate rich interactions including purchase transactions, offer targeting/delivery, and other personalized experiences. The accounts are made accessible by the associated peripheral devices, including clients such as user clients 108, 109, and merchant-based clients such as point of sale (“POS”) client 120 and management client 121, which extend the reach of network 100 to a user's computer 109, mobile device 108, the merchant's counter via POS 120, and any other device that can interface with network 100.

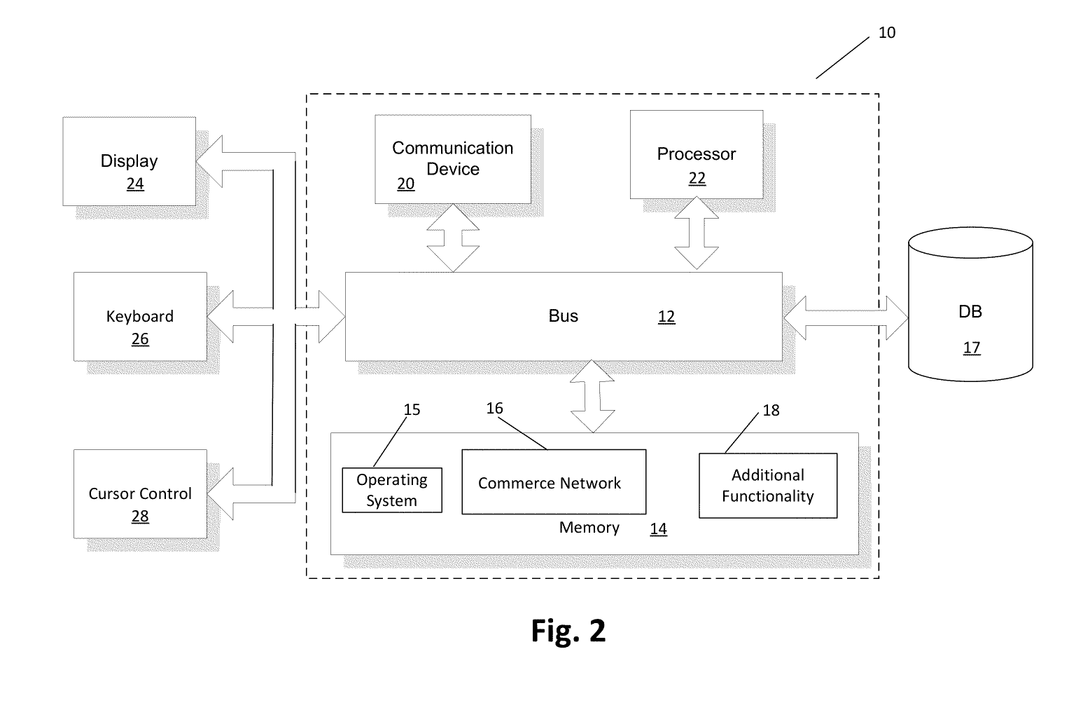

FIG. 2 is a block diagram of a computer server/system 10 that can implement network 100 of FIG. 1, and well as any of the associated peripheral devices of FIG. 1, in accordance with an embodiment of the present invention. Although shown as a single system, the functionality of system 10 can be implemented as a distributed system. Further, the functionality of network 100 can be implemented by a single system 10, or by multiple systems 10. Further, any of the devices/functionality shown in FIG. 1 can be implemented by one or more system 10s. Finally, all elements shown in FIG. 2 are not required in any implementation of any portion of network 100.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other known method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a commerce network module 16 that provides the functionality of commerce network 100 of FIG. 1, as disclosed in more detail below. System 10 can be part of a larger system, such as a database management system or a financial management system. Therefore, system 10 will typically include one or more additional functional modules 18 to include the additional functionality. A database 17 is coupled to bus 12 to provide centralized storage for modules 16 and 18.

Referring again to FIG. 1, each user of network 100 is represented by user account 102. User account 102 holds basic profile information, global and merchant specific payment preferences, and any number and type of tender instruments including debit cards, private label cards, gift cards, bank accounts, coupons, offers, loyalty cards, loyalty points, etc. Users may access and manage this information through a range of user clients such as clients 108, 109. The user clients can be any device that allows access to network 100 over the Internet or other network, and may include an Internet browser. The clients may include a web page, mobile applications, and tablet interfaces which enable users to add/delete tender instruments, view a transaction history, and perform a range of other account management functions. User account 102 facilitates the collection and management of any tender type from any platform (e.g., web page, mobile, social) by the user. User account 102 also enables the seamless sharing of these tender instruments with the merchant at the time of transaction via network 100.

Each merchant using network 100 creates a merchant account 104 that represents the merchant on network 100. Merchant account 104 holds basic information such as store address/location(s) and merchant acquiring information that defines how payment should flow to the merchant. Merchant account 104 also holds detailed user and store level transaction information and analytics. Finally, merchant account 104 contains information about merchant clients such as POS client 120 and management client 121 which may access and interact with merchant account 104. An authorized merchant POS client such as client 120 may connect to network 100 via POS or merchant APIs 122 to facilitate user authentication and transaction settlement from the POS. Similarly, merchant management client 121 can interact with merchant account 104 via a web page or tablet interfaces to access real-time analytics, configure account settings, or interact with engines 110, including the business optimization engine. The business optimization engine allows merchants to tailor rich offers, loyalty rewards, and other promotions to individual users or user segments to assist with customer acquisition and retention.

Each issuer 130 of tender using network 100 has a corresponding issuer account 106. An issuer account 106 may include an authorization policy, an authorization mechanism and a settlement mechanism for each tender type the issuer supports. The authorization and settlement mechanisms specified for each tender are executed by the transaction engine as it processes a transaction. While traditional forms of tender use existing infrastructure for authorization and settlement, newer forms of tender may use new authorization and settlement mechanisms. Therefore, in one embodiment the issuer API 132 includes new authorization and settlement mechanisms, including authorization by web services and direct settlement.

As discussed, embodiments interconnect users and merchants/retailers to enable complex transaction processing and other functionality. To initiate the functionality of network 100, in one embodiment a user downloads an application to a mobile device and sets up a user account 102. An account may be set up through a website, a mobile application, or any other method.

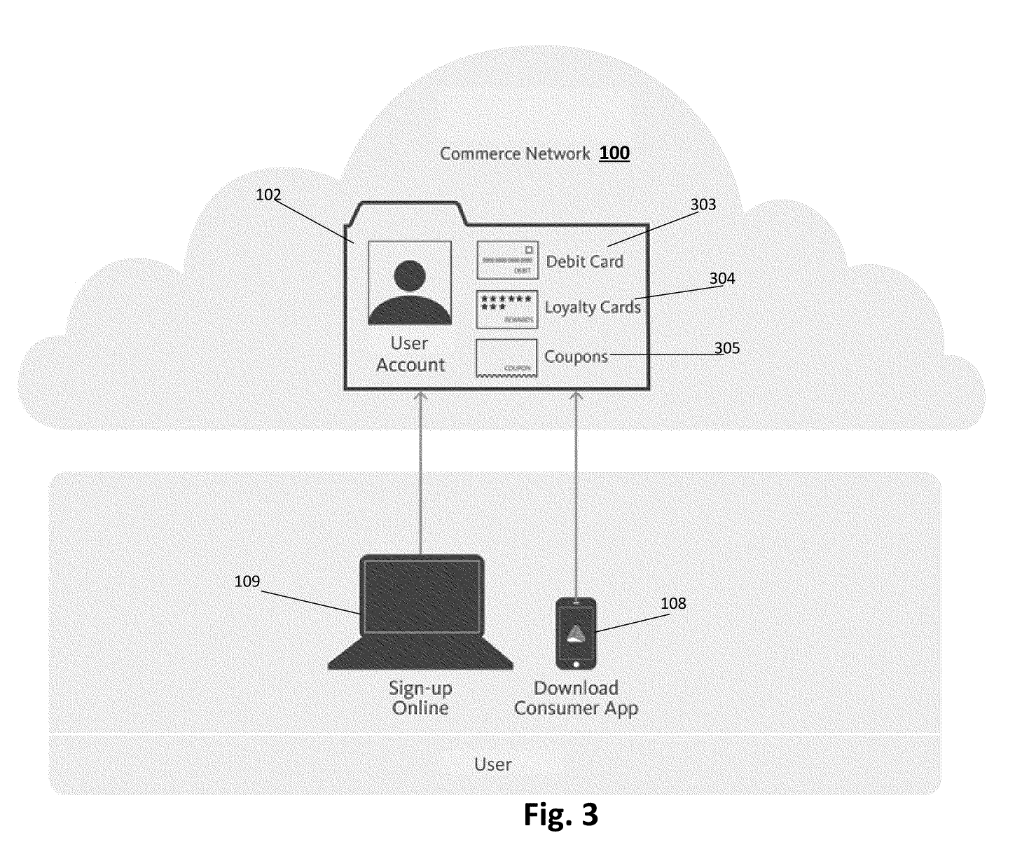

FIG. 3 is an overview diagram illustrating a user initiating the functionality of network 100 of FIG. 1 in accordance with one embodiment. In one embodiment, the user could use a website via user client/computer 109 to create a user account 102, set up the password for the account, and create a personal identification number (“PIN”). The user could also use the website to populate the user account 102 with a debit card 303, a loyalty card 304 and a coupon 305. Other tender instruments are possible. The user can then download a “mobile commerce” application to the user's client/mobile phone 108 and sign into account 102. At this point the user is ready to use network 100. Alternatively, the user can sign-up in a similar fashion through a retailer-branded web interface or mobile application.

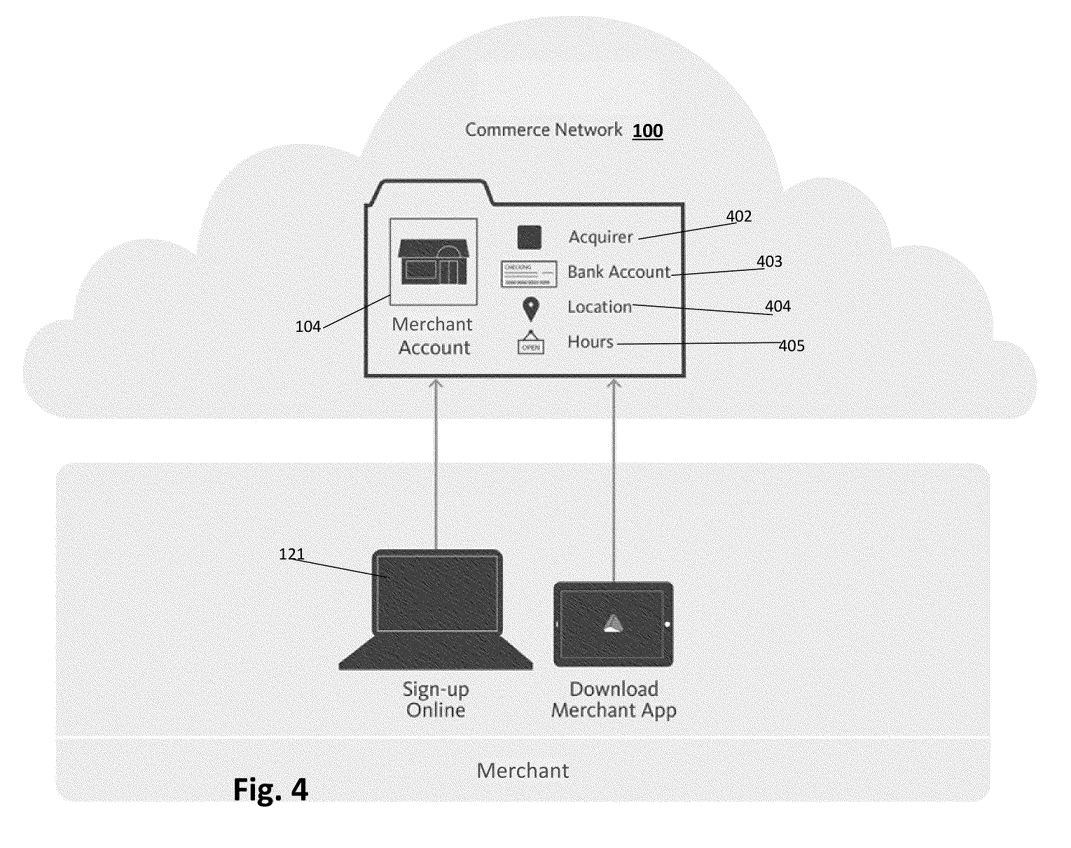

Similarly, to initiate the functionality of network 100, in one embodiment a merchant first creates a merchant account 104 representing the corporate entity and then creates store accounts for each physical store. FIG. 4 is an overview diagram illustrating a merchant initiating the functionality of network 100 of FIG. 1 in accordance with one embodiment. To accomplish this the merchant would use a web page via merchant client 121 or other method. In the example of FIG. 4, the merchant has a single store and creates merchant account 104 and a store account of the single location 404 having store hours 405. The merchant would add information to the store account describing how payments should be handled for that store location. Specifically, the merchant will designate which acquirer 402 and account 403 processed funds should flow into. Acquirer 402 is the merchant's acquirer, also referred to as a payment “processor”. Examples of payment processors include First Data Corp. (“FDC”), Fifth Third Processing Solutions, etc. Account 403 is the merchant's corporate level account or the individual store's account on network 100.

Once the store account is setup, in one embodiment the merchant integrates a “Beanstalk Library” into the merchant's POS system. The Beanstalk Library allows the POS system/client 120 to initiate transactions on network 100, much the same way that these systems initiate transactions with a traditional acquirer. In one embodiment, the Beanstalk library combines the functions of the following known integration products:
Credit processing gateways (e.g., First Data Corp, Fifth Third, etc.);
Processing solutions (e.g., Chase Paymentech, Heartland Processing, etc.);
Gift card processing hosts (e.g., First Data Valuelink, Store Value Solutions (“SVS”), ValuTec, Givex, Mercury Gift Cards, etc.);
Coupon redemption systems (e.g., NCH, Inmar, etc.);
Loyalty providers (e.g., City Retail Services, SAP, TSYS, etc.);
Voucher providers (e.g., Groupon, Living Social, etc.); and
POS hardware platforms (e.g., NCR, Micros, etc.).
   Once integrated, POS 120 is ready to initiate payments on network 100. Payments initiated via a beanstalk API are processed as described by the rules set up in the store account for the physical store that initiates payment.

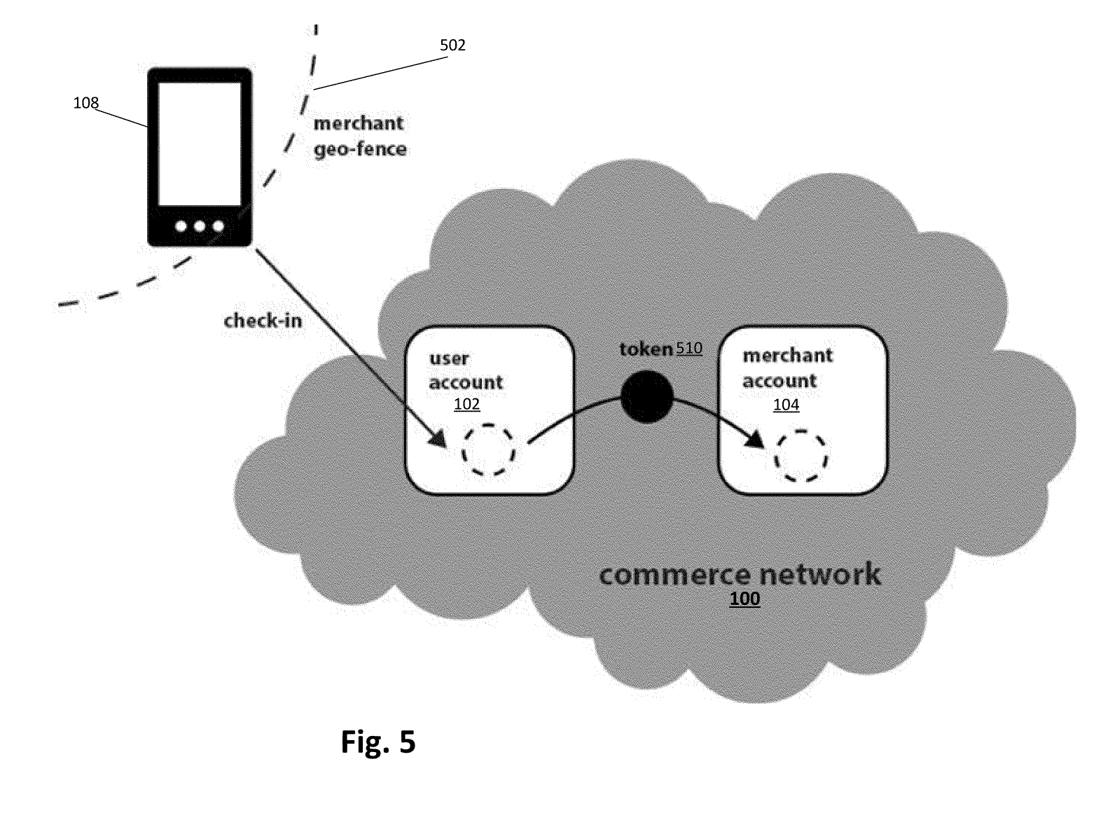

Once at least one user and one merchant and store account, and one issuer has been set up, transactions can occur on network 100. FIG. 5 illustrates a user being checked into a store with a store account in accordance with one embodiment. The example beginning at FIG. 5 is for a transaction with a single item and a single payment instrument.

As shown in FIG. 5, network 100 via the mobile commerce application downloaded on the user's mobile device 108 observes the user's location and uses this information to determine when the user enters a store that has a corresponding store account on network 100. The downloaded mobile commerce application uses GPS signaling in one embodiment to determine when the user enters the store by crossing a merchant geo-fence 502. The application uses various GPS-related systems for determining location and communicating with both commerce network 100 and the user, including Bluetooth, Bluetooth low energy (“BLE”), iBeacon and other protocols. A geo-fence is a virtual perimeter for a real-world geographic area such as the store.

To prepare the user to pay at the store, the user mobile application sends a check-in request to network 100 indicating that network 100 should prepare the user to pay at the store. Network 100 receives the check-in request and creates a single-use payment token or “Bean” 510 for the user. Network 100 registers the token 510 with the store and replies to the user's mobile phone 108. If desired by the user, the mobile phone 108 can be programmed to buzz or otherwise alert the user to let the user know that they are ready to pay at the store. Similarly, if the manager at the store is looking at POS client 120 or Management Client 121, the manager will notice that another user has entered the store by an indication that pops up on client 120 or 121.

A Bean, such as Bean 510, in general is a session object that captures the interaction events between a user and a single store location. In one embodiment, a Bean object lifecycle begins when a user enters the store location and ends when a user leaves the store location. Other lifecycle initialization triggers and ending triggers are possible. For example, a Bean could be instantiated in an anonymous transaction by the store at the time of a transaction initiation, and closed when the transaction processing is complete. Bean 510 can be used for a single transaction, or it may be applied to a user session in a store that spans multiple refunds and purchase transactions.

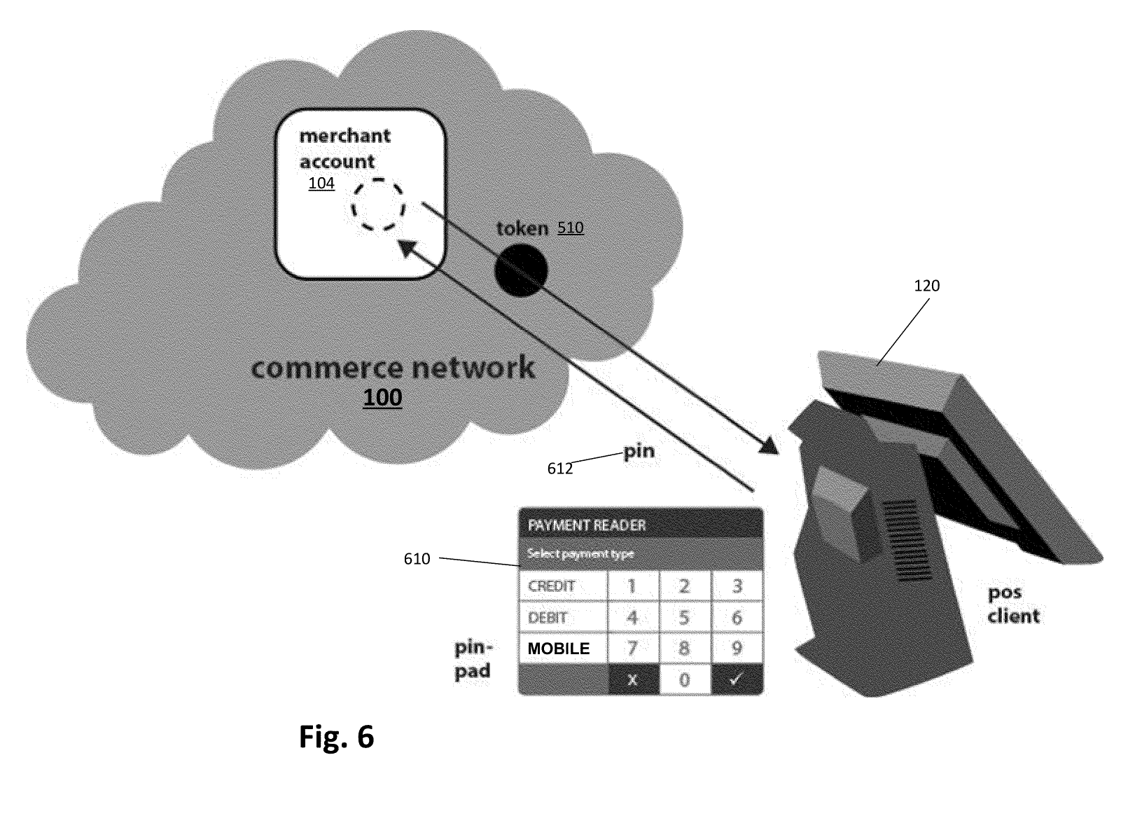

In the current example where the user purchases a single item, the user makes the selection of the item and heads to the checkout. FIG. 6 illustrates POS client 120 at the merchant and using merchant account 104 to checkout the user in accordance with one embodiment. POS client 120 displays multiple methods of payment on display 610, including credit and debit. One of the options is a “mobile” option indicating payment via network 100. As the cashier rings the user up, the user selects the “mobile” option and enters the PIN number in the existing PIN pad.

At this point POS 120 uses the integrated Beanstalk Library to authenticate the user via the PIN. To achieve this, the POS software passes the user's PIN into the Beanstalk Library and requests an authentication. The Beanstalk Library sends the request to network 100 where the user's PIN is used to validate the user. Once validated, the payment token 510 (that was created when the user entered the store) is returned to POS client 120. POS client 120 is now ready for checkout.

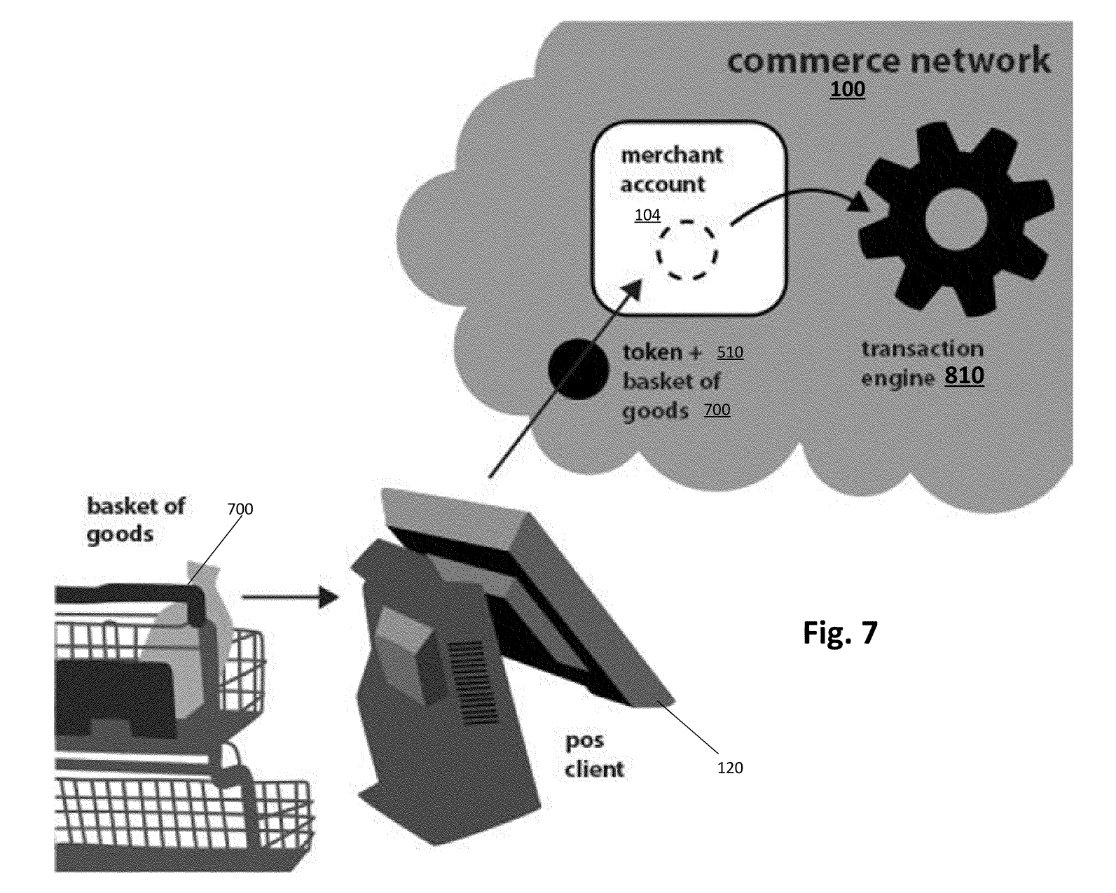

FIG. 7 further illustrates the checkout process based on a basket of goods selected by the user in accordance with one embodiment. The basket of goods 700 is the line level data of the one or more items that the user has selected for purchase. Basket of goods 700 includes a full description of each item, including the brand, price, size, stock keeping unit (“SKU”), etc. In general, the description includes the core information of SKU, price, tax and a list of additional key-value descriptors to cover item or merchant specific characteristics such as color, category, size, condition, etc. Once the cashier finalizes the transaction at POS client 120, basket of goods 700 that the user selected is passed into the Beanstalk Library. Basket of goods 700 (i.e., line level data) and payment token/Bean 510 are then sent to network 100 for processing.

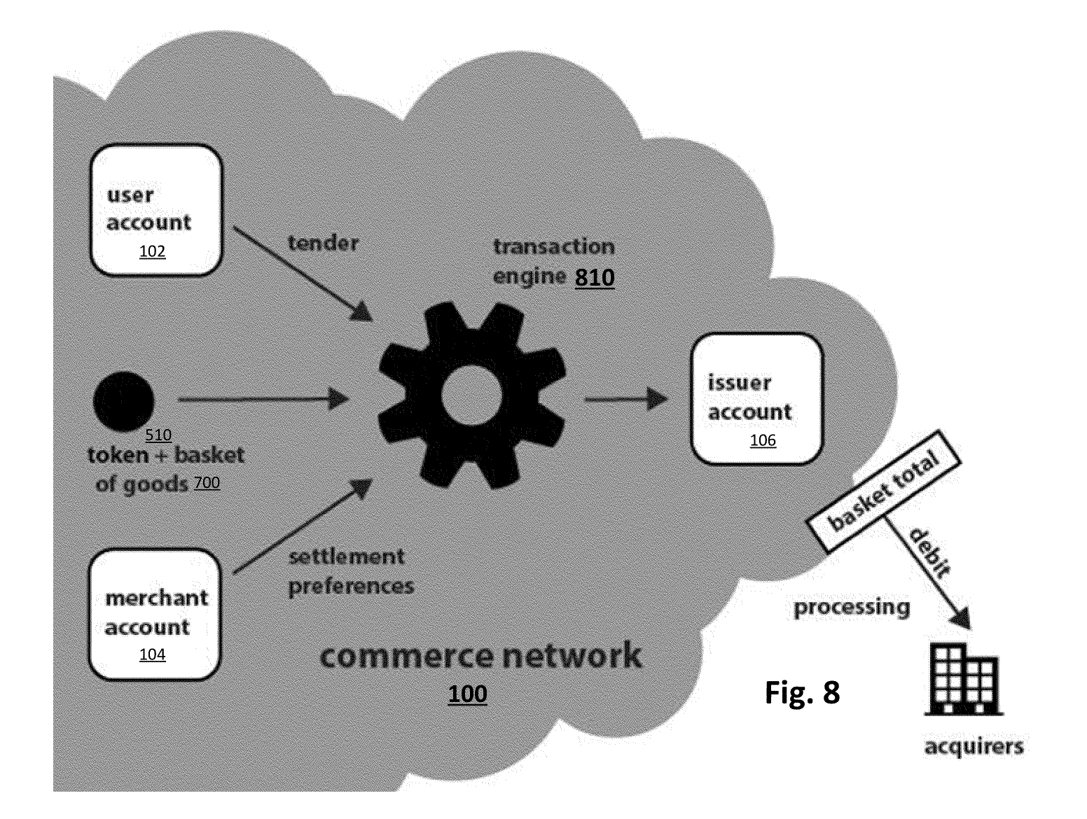

When the transaction request reaches network 100 it is passed into a transaction engine 810. FIG. 8 illustrates the functionality of transaction engine 810 in accordance with an embodiment of the present invention. The checkout process is based on basket of goods 700 selected by the user and the corresponding line level data in accordance with one embodiment. Transaction engine 810 reviews the basket of goods 700 being purchased, compares them to the payment instruments in the user's user account 102, and selects the correct payment instrument(s) to use. If the user had any item-specific coupons, they would be applied here. However, in this example the user has no coupons and pays the full amount with the user's debit card.

Once transaction engine 810 has selected the payment instrument (in this example, the user's debit card), it looks up the store account's processing preferences. In this example, the store uses First Data Corporation, or other payment processor for processing. Transaction engine 810 sends a request to FDC, or other payment processor or partner, to put the full total of the transaction (e.g., $5.00) on the user's debit card and waits for the response.

Assuming the transaction is approved, transaction engine 810 sends a success response to POS 120. It then uses the basket of goods to create a digital receipt and notify the user of the purchase and an available receipt. Transaction engine 810 similarly creates a receipt for the store and updates its real-time analytics to reflect these sales.

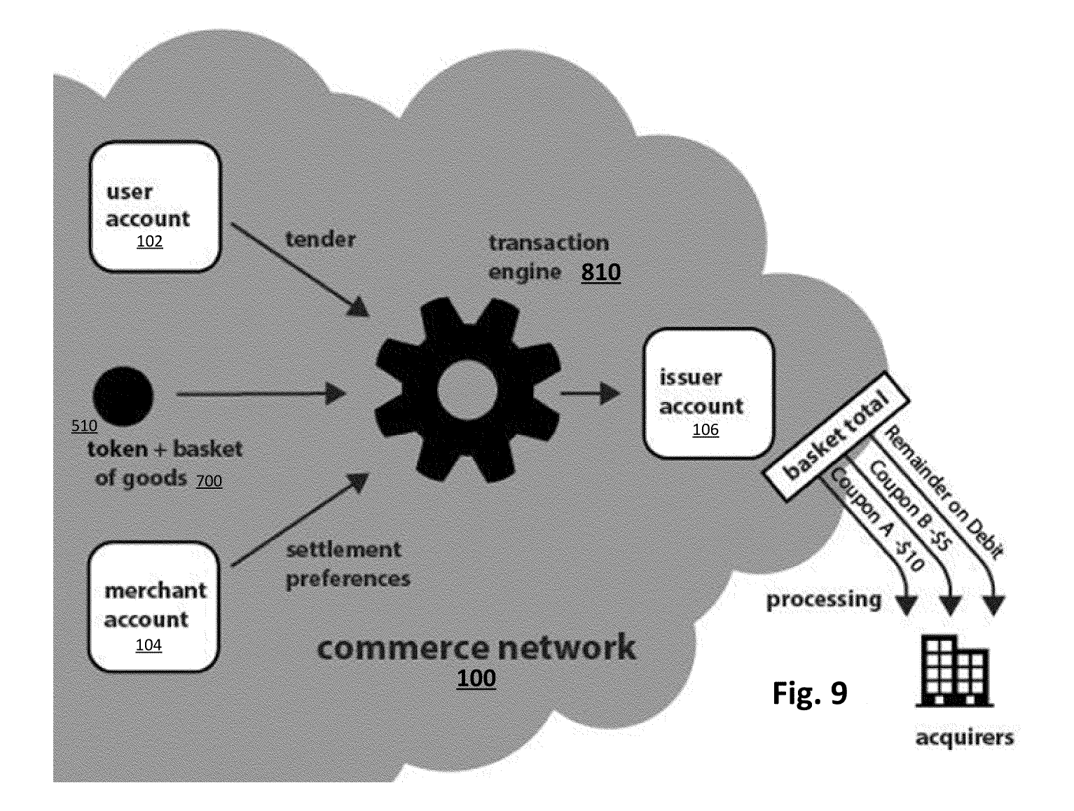

In a variation of the preceding example, assume the user has selected multiple items, and has manufacturer coupons in the user account 102 for two of the items: a $10.00 off coupon for “Item A” and a $5.00 off coupon for “Item B.” In this example, the user's check-in and PIN authentication proceeds in the same manner as disclosed in the above example. However, when the transaction reaches network 100, it is processed differently. FIG. 9 illustrates the functionality of transaction engine 810 with multiple items and multiple payment/tender options in accordance with an embodiment of the present invention. When transaction engine 810 compares the basket of goods 700 to the user's user account 102, which stores the coupons, it matches Item A to one of the coupons, and matches Item B to the other coupon. Network 100 is able to do this because it has received line level data for the basket of goods from POS 120. It then applies these payment instruments to the basket alongside the debit card.

Once the tenders are selected, transaction engine 810 sends three transaction requests to the acquirer/processor:
A $10.00 Automated Clearing House (“ACH”) payment from the Item A manufacturer to the store.
A $5.00 ACH payment from the Item B manufacturer to the store.
The remainder of the transaction is placed on the user's debit card.

Transaction engine 810 then waits for the PIN debit transaction to complete but not the ACH transactions, since they can take much longer to complete. Receipts are generated and they include information about the redeemed offers. If these offers were part of a specific campaign, the campaign analytics would be updated to reflect this usage.

As disclosed above, network 100 enables merchants to accept any and all forms of tender, to complete complex multi-tender transactions, and to effectively engage with customers across new channels. Specifically, transaction engine 810 joins user accounts 102, merchant accounts 104 and issuer accounts 106 to enable the flexible settlement of any type and any number of tenders for a single transaction. In turn, this flexibility empowers merchants to reach customers through new channels which require new incentives/tender types for effective engagement. For example, mobile web engagement might require the creation and distribution of mobile advertisements/offers, a “Facebook” engagement might require Facebook Offers or the distribution of Facebook Credits, and an e-mail marketing campaign might require the creation and distribution of e-mail offers/Groupon certificates, etc. By supporting any tender type, network 100 effectively unlocks these new channels to merchants and turns them into powerful and measurable paths to reach customers. The resulting platform provides a medium for users and merchants to seamlessly engage with one another and fosters rich multi-channel relationships. Network 100 allows merchants to promote, distribute, accept and analyze results for new tender types that most directly support their core business.

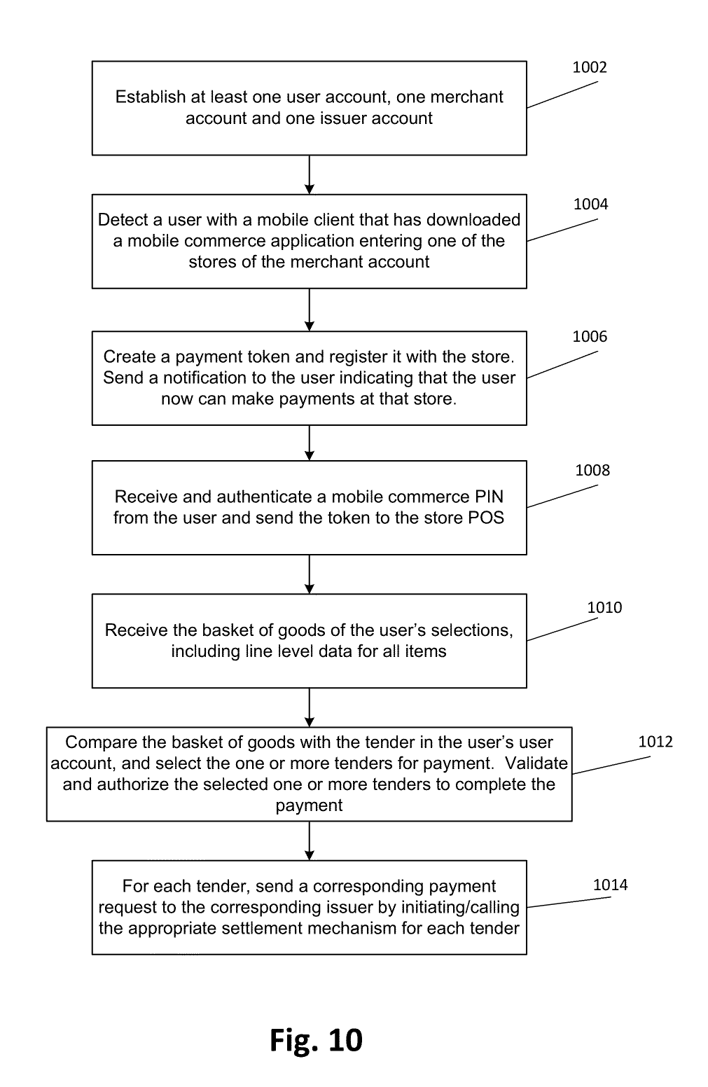

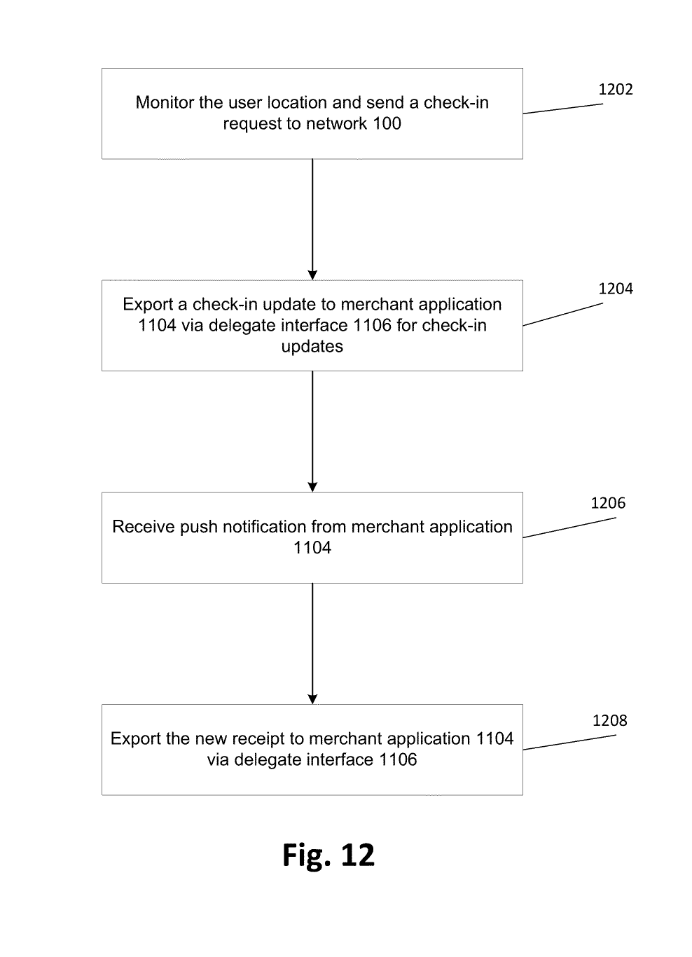

FIG. 10 is a flow diagram of the functionality of commerce network module 16 of FIG. 1 when providing mobile commerce and conducting mobile transactions in accordance with one embodiment. In one embodiment, the functionality of the flow diagram of FIG. 10, and FIG. 12 below, is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software. The functionality of FIG. 10 can be implement by system 10 as shown in FIG. 2, or distributed over multiple system 10s.

At 1002, at least one user account, one merchant account and one issuer account is established. Each user account holds basic profile information, payment preferences and one or more tender instruments, including debit cards, private label credit cards, gift cards, bank accounts, coupons, offers, loyalty cards, loyalty points, etc. Each merchant account holds basic information such as store address/location(s) and merchant acquiring information that defines how payment should flow to the merchant. Each issuer account may include an authorization policy, an authorization mechanism and a settlement mechanism for each tender type the issuer supports.

At 1004, a user with a mobile client that has downloaded a mobile commerce application, such as a smartphone, is detected entering one of the stores of the merchant account. In one embodiment, the user is detected when the user crosses a geo-fence of the store using the user's smartphone GPS capability.

At 1006, a token or Bean is created and registered with the store. A notification is optionally sent to the user indicating that the user now can make payments at that store. This is the completion of a first level of authentication. At this point, the store is able to communicate with the user via the mobile client, such as providing store information, advertisements, coupons, etc.

At 1008, after the user selects one or more items to purchase that form a basket of goods, the user approaches the store's POS, selects the option to pay using the mobile commerce network, and enters the mobile commerce PIN that was associated with the user when the user created the user account. The PIN is received by the commerce network 100 and is then authenticated at the network, and the token is sent to the POS in the store. This is the completion of a second level of authentication.

At 1010, the basket of goods of the user's selections, including line level data for all items, is received by the network 100 for processing.

At 1012, the basket of goods is compared with the payment instruments or tender in the user's user account, and the appropriate one or more tenders are selected, validated and authorized to complete the payment (referred to as tender “extraction”). The tenders can include debit cards, credit cards, electronic coupons, electronic group buying instruments such as Groupon “deals”/certificates, electronic gift certificates, etc. When more than one tender can be used to complete the payment, the “best” tender is selected. For example, coupons or gift certificates will be used before debit or credit cards, and the remaining balance, if not completely satisfied by the coupon or gift certificates, can be satisfied by the debit/credit cards.

At 1014, each of the one or more payment requests corresponding to the tenders are sent to the corresponding issuer by initiating/calling the appropriate settlement mechanism for each tender.

### Users

As discussed above, every user of network 100 has a user account 102. User account 102 holds basic profile information, global and merchant specific payment preferences, transaction history, and any number and type of tender instruments including debit cards, credit cards, private label cards, gift cards, bank accounts, coupons, offers, loyalty cards, loyalty points, etc. The tender instruments in the User account 102 are accessible at the time of transaction and are used to facilitate payment in the order/fashion prescribed by the user. The desired use of instruments and the order in which they should be used is determined by the user in a user account preferences file. In one embodiment, these preferences may be set once and not modified again, or the user could manually adjust these preferences before each transaction.

Users can create, access and manage their user accounts 102 through a range of user clients (e.g., user clients 108, 109, or any devices that enable the user to interface with network 100). These clients include web pages, mobile applications, and tablet interfaces which enable users to add/delete tender instruments, view transaction history, and perform a range of other account management functions. User clients access user account data via commerce network 100 and present a consistent set of instruments across interfaces. For example, whether a user looks at the contents of user account 102 on web client 109 or on mobile client 108, the user will see the same set of instruments.

In one embodiment, a primary use for the user clients is adding and managing instruments of tender. When a user adds an instrument to user account 102, the instrument data is sent to network 100 for secure storage in user account 102. In one embodiment, once instrument data is added to user account 102, the data exists exclusively in user account 102 and is never shared with or stored in any of the clients. However, in one embodiment user account 102 shares instrument references with the user clients so that the clients can actualize a user interface that lets users examine, delete and configure the instruments in user account 102. Instrument references contain only enough information about the instrument in one embodiment to allow it to be meaningfully displayed in the user interface. Because the user clients do not store sensitive tender data, they are not a point of attack from which credentials may be extracted.

The user clients may also serve as points of user engagement and tender discovery before and after a transaction. For example, a merchant might present an offer to a user when the user arrives at a store to drive sales of an item that is overstocked, or a merchant might provide an offer attached to a receipt to incentivize the user to return to the store that same week. In these examples, the user clients also become channels for delivering rich personalized experiences and presenting new instruments of tender.

The user clients, such as user client 108, 109 are merchant-centric. Unlike some prior art mobile wallets that are organized around object types (e.g., payment credentials, offers/coupons, loyalty/reward cards, receipts, etc.), the user clients in accordance with one embodiment are organized around user/merchant relationships. By default, user account data is organized by merchants and this serves as a user client's organizing principle. The default view in a user client in one embodiment is a list of merchants organized by location, favorites or any other arrangement. Users can pivot data around themselves (e.g., to view receipts across all merchants) in another view.

Once a user retrieves a detailed view of a specific merchant, the user is able to see a view of their entire relationship with the merchant. This view, referred to as a “merchant relationship feed” is an intelligent sort of all past, present and potential future user/merchant interactions. An intelligent algorithm weighs recency, importance and other factors to develop a feed of transactions, offers, rewards, news and other user/merchant engagement opportunities.

Network 100 enables merchants to reach customers through new channels which often require new incentive/tender types for effective engagement (e.g., mobile advertisements/offers for mobile channels, Facebook Credits/Offers for Facebook “likes”, etc.). Across these new channels, users generally engage while they are online and logged into a range of third party accounts such as Pinterest, Facebook, Google, Twitter and Yahoo. Network 100 allows users to link their user accounts to these third party accounts to enable seamless discovery, clipping, sharing and engagement with tender available on these channels. To create this link, in one embodiment network 100 uses “OAuth” to connect user accounts to these third party account. OAuth is a known open standard for authorization and provides a process for end-users to authorize third-party access to their server resources without sharing their credentials (typically, a username and password pair), using user-agent redirections. In other embodiments, other authorization mechanisms can be used. A user may elect to link user account 102 to any or all third party accounts made available by network 100.

When a third party account is linked to user account 102, it is granted a set of capabilities to interact with user account 102, which might include adding tender instruments into user account 102. For example, a user who is logged into Yahoo might clip an offer from an email message directly to the user's user account 102. Similarly, when a user account 102 is linked to a third party account, with user permission a user account 102 may interact with the third party account. For example, a user account 102 might gain access to post something to a user's Facebook Wall or Twitter Stream. This linking of accounts gives users a federated commerce capability with a broad online presence. The federated commerce capability actualizes a chain of authentication so that no matter what the online context, users are able to save to and publish from their user account 102.

While the above describes using account federation to add tender instruments from Twitter and Facebook, for example, this mechanism extends to any secure online account, including user accounts with financial institutions, media outlets and merchants. Therefore, a user logged in to a merchant or issuer website could similarly push things like offers or payment cards into their user accounts.

When a third party account is linked to user account 102, it is granted a set of permissions which can include the ability to add tender instruments to user account 102 (including debit cards, private label cards, gift cards, bank accounts, coupons, offers, loyalty cards, loyalty points etc.). To add instruments to user account 102, third parties can interact with a defined set of User Account APIs. With user permission, these third parties can then push instrument data to the user account. These APIs can implement using known web service mechanisms such as Representational State Transfer (“REST”) and data payloads encoded as JavaScript Object Notation (“JSON”).

If a user is not logged on to network 100 when trying to save a new instrument to the user account 102, the user will be prompted to login to network 100 or any third party account. Similarly, if a user is already logged into a third party account that is not yet federated to user account 102, the user will be prompted to link that account to user account 102 or to login using a valid user account 102.

For mobile applications where an application may not use the notion of a “logged in” account (e.g., an advertisement in a video game), the client application exposes local APIs by which an application may pass data to the client application to be saved. In this embodiment, federated authentication is provided by the client installed on the user client. In one embodiment, an intent or uniform resource identifier (“URI”) exchange is used to pass tender data into the client application which will receive and save the instrument data.

In one embodiment, user account 102 plays a large role in the settlement of tender at the time of a transaction. When a user makes a purchase, the merchant passes the user authentication token 510, also referred to as a “Bean”, loaded with a basket of goods to network 100. Network 100 uses token 510 to access user account 102 and passes the basket of goods and user account 102 to transaction engine 810 for processing.

Transaction engine 810 examines the basket of goods and full set of instruments in user account 102 and applies a business algorithm to determine which tender instruments to use for the transaction. Transaction engine 810 then initiates the transaction and updates user account 102 as necessary. For example, offers that are redeemed to settle the transaction would be marked as used. Further, if a gift card is used in a transaction, its balance would be updated in user account 102.

The online and federated nature of user account 102 enables it to: (1) gather tender instruments from any online context; (2) make those instruments available for processing at the time of transaction; and (3) update user account 102 after transaction processing so that the user can immediately see the results of the transaction.

### Merchants

As previously discussed, in one embodiment every merchant that participates in network 100 has a merchant account 104. Merchant account 104 holds basic profile information, an arbitrary number of stores which represent physical locations for the merchant, geo-fence properties for each store, merchant acquirers/processors used to finalize settlement of acceptable forms of tender, etc. In addition, merchant account 104 may hold any merchant specific business logic that should be applied to transactions.

To provide flexibility, embodiments allow merchants to arrange stores into arbitrary sets/store groups (e.g., regional groups) to simplify the management tasks. A merchant can then use these groups to set store policies or publish incentives/offers in varying granularities. For example, a merchant could publish a national offer to all stores, a warm weather offer to a group of warm weather stores, a local offer to a single store or individual offers to specific customers or customer groups, based on any range of demographics, historic purchases, online browsing, or other characteristics or actions.

Store groups can also be used to delegate administrative permission for the stores. For example, a regional manager could be given permission to set offers/store policies for a regional store group or a local store manager could set policies and promotions for one store only.

Merchants can connect to network 100 to authenticate users and initiate transactions through approved merchant POS clients, such as POS client 120. These merchant POS clients may include existing and future POS infrastructure which is connected to network 100 via merchant APIs 122. In order to authenticate users and initiate transactions, a POS in one embodiment first authenticates itself to network 100. This initial authentication includes an exchange of merchant account 104 username, password, and predefined POS identifier (e.g., “Lane 17”). In addition, key material is also exchanged with the POS to more strongly authenticate it.

Once authenticated, merchant POS client 120 (via API 122) is used to authenticate in-store users to network 100. When a user elects to pay using network 100, the user is prompted to enter the PIN on the terminal attached to the POS. For example, the terminal might be a PIN-pad from Verifone Systems Inc., or a touch-screen PIN-pad when using a tablet/mobile POS. Once the PIN is collected, it is sent to network 100 where it is compared to the PINs of users checked into the store. Therefore, the PIN is used both to authenticate and disambiguate the user. If there are multiple users with the same or even similar PINs in the store, network 100 in one embodiment presents a challenge question to the user. For example, the user may be asked to enter a date of birth, street address number, phone number or other information into the same terminal. This information would then be similarly passed to network 100 for authentication.

Once a user is authenticated, as described, the POS receives a token, or Bean, for the transaction at hand. The Bean is an opaque token that carries no intrinsic value and does not return any tender instruments to the POS. Accordingly, the Bean does not require any PCI security standards council or similar level protection by the merchant.

Once the user has authenticated to network 100 via the POS, the cashier/teller at the POS moves forward with the merchant's standard purchase flow until it is time to complete the transaction. With a traditional transaction, the POS/cashier would send a user instrument (for example a Visa card) and a basket total (for example $100) to a network for authorization and settlement. However, for network 100, the cashier sends the token/Bean which includes the complete basket of goods including line level data to network 100. With the basket of goods as a guide, transaction engine 810 then joins the user, merchant and issuer accounts to process the transaction. Once cleared, network 100 returns an updated receipt to the POS including any price modifications. This enables the user have a real-time view of the final purchase price and confirmation of which instruments were applied to clear the transaction.

Merchants can create, access and manage their merchant accounts 104 through a range of merchant clients (e.g., management client 121). These clients include web pages, mobile applications, and tablet interfaces which enable designated managers to monitor their merchant account, add/delete stores, view transaction history, and perform a range of other account management functions. A management console provides merchants with a real-time view of activity in their stores and across channels, such as how many customers are in their stores segmented by customer type, subject to user permission, or a customer's individual wish lists or purchase history. Additionally the management console provides a real-time view of purchase velocity, the performance of promotional campaigns, and custom monitoring/alerts based on any information available on network 100. The management console also provides access to the business optimization engine, which can be used to optimize and generate personalized advertising, incentive, and promotional campaigns across channels to maximize revenue and customer engagement.

### Issuers

As disclosed above, every issuer of network 100 has a corresponding issuer account 106. Issuer account 106 details the issuer's tender types, and the authorization policy, authorization mechanism, and settlement mechanism for each form of tender. An authorization policy is a contract that describes how and under what circumstances authorization for the tender should occur. An authorization mechanism describes how the tender should be authorized by the issuer should the authorization policy deem it necessary. Finally, the settlement mechanism describes how settlement should be actualized for the tender. In one embodiment, network 100 splits the authorization and settlement of tender into separate phases to provide a flexible solution capable of handling a broad set of tender types.

For example, if Groupon were to issue an offer that could be redeemed on network 100, Groupon would first create an issuer account or an account is created on behalf of Groupon. Groupon would specify an authorization policy, an authorization mechanism, and a settlement mechanism for the Groupon tender. Groupon could specify: (1) an authorization policy that required real time authorization for any Groupon tender; (2) an authorization mechanism that used a web services call to perform the authorization for the tender; and (3) an ACH settlement mechanism that used ACH to move the money from Groupon to the merchant. In some transactions, authorization and settlement could be part of the same action for a specific tender type. For example, the authorization mechanism could be set to null in the issuer account, which would shift the responsibility of authorization to the settlement agent.

For traditional payment instruments where the issuer (e.g., a bank) may not be have a corresponding issuer account on network 100, a delegate issuer account may be automatically configured. For example, a debit card would use a predefined debit Issuer account delegate that would specify authorization and settlement using a traditional debit network.

An issuer can use an issuer management console or other method to facilitate the setup of issuer accounts 106 and management of the authorization policy, authorization mechanism, and settlement mechanism for each tender. The issuer management may also provide real-time analytics about issuer tender on network 100, the number of transactions inflight, the outstanding balance due, settlement, etc.

The authorization and settlement mechanisms specified for use by the issuer can be implemented in a number of ways. Embodiments include a set of issuer APIs 132 and reference implementations that use next generation authorization and settlement mechanisms. For example, when using Groupon-based tender, as described above, in one embodiment Groupon would use the authorization mechanism defined in issuer API 132 to implement authorization via a web services call.

### Mobile SDK

In one embodiment, mobile clients interfacing with network 100, such as client 108 of FIG. 1, include mobile software development kits (“SDK”s) that can be used to provide functionality to other applications running on the mobile client, such as Android and iOS based merchant/retail applications. The mobile SDK in one embodiment provides the following functionality:
Location services and check-ins;
Notifying a merchant application of events such as check-in or purchase;
Handling push notifications for in-store events;
Communicating with network 100 to retrieve information such as news items or receipts; and
Enabling engaging with and “clipping” incentives in the merchant application and saving them to network 100.

In one embodiment, the mobile SDK provides this functionality only for merchant-specific operations on network 100. In one embodiment, the merchant application can only request a check-in to one of the merchant's own stores (i.e., no other merchants' stores). Further, in one embodiment the merchant application can likewise only query receipts for past transactions between the user and the specific merchant, instead of any merchant that interfaces with network 100.

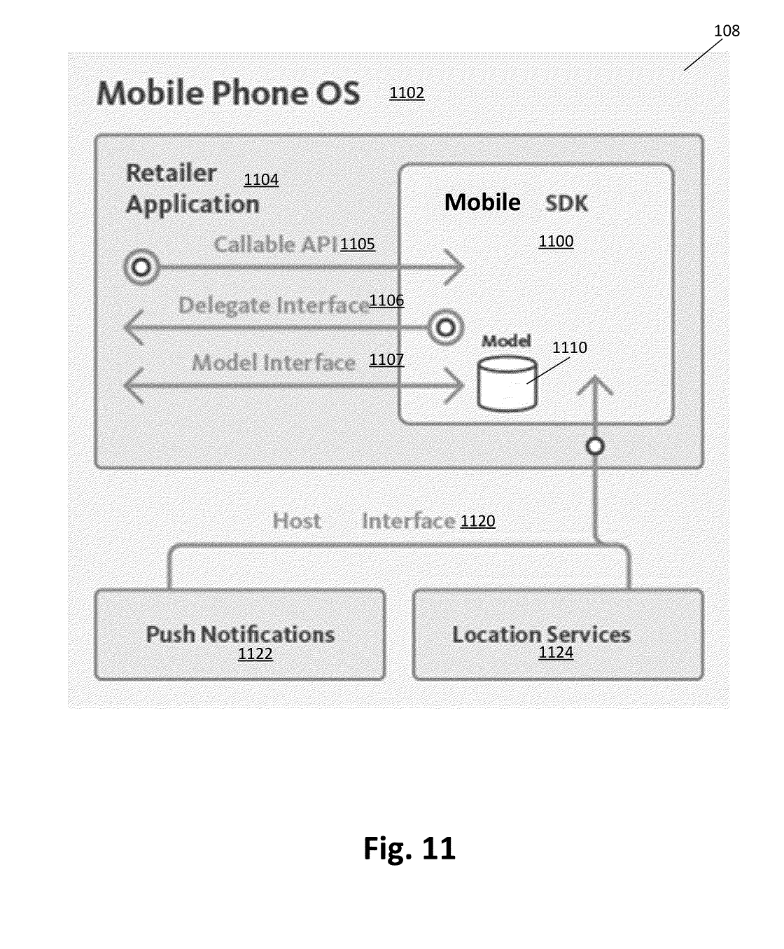

FIG. 11 is a block diagram illustrating a mobile SDK 1100 within a mobile phone operating system in accordance with one embodiment of the invention. In one embodiment, mobile SDK 1100 is executed by a processor in mobile client 108, and can be implemented by system 10 of FIG. 2 as part of a mobile phone operating system 1102. Mobile SDK 1100 includes a model 1110 that represents a user's state on network 100. A mobile merchant/retailer application/app 1104 is also executed by a processor in mobile client 108, and may be a mobile application obtained from an application store. Merchant app 1104 interfaces with mobile SDK 1100 via a callable API 1105, a delegate interface 1106, and a model interface 1107. Mobile SDK 1100 in one embodiment is part of the mobile commerce application that is downloaded to a mobile device as disclosed above in conjunction with FIG. 3.

A host interface 1120 interfaces a host application with mobile SDK 1100. Interface 1120 allows, for example, push notifications 1122 and location services 1124 to provide data to mobile SDK 1100. In one embodiment the host application is the application that is “hosting” mobile SDK 1100 (e.g., from a retailer such as “Macy's) and is separate and remote from mobile client 108. Merchant application 1104 will likely be also provided by the retailer, while mobile SDK 1100 may be provided by a 3^{rd} party, such as the entity that implements commerce network 100.

In one embodiment, to leverage and use the functionality of mobile SDK 1100, merchant app 1104 codes to the exposed SDK interfaces to receive event notifications and query the state of the user on network 100, as necessary. In addition, retailer application 1104 enables certain critical system services such as push notifications 1122 and location services 1123 so that these capabilities can be used by mobile SDK 1100.

In one embodiment, to aid integration efforts, mobile SDK 1100 exports a status vector (i.e., an array of status fields) that the retailer application 1104 can query at will. On initialization, mobile SDK 1100 seeks to validate its integration. In the case of a mis-integration (e.g., location services are not enabled, etc.) an error vector can be consulted to simplify/ease completion of integration.

Callable API 1105 in one embodiment can be called anytime by merchant app 1104 to access the user's real time state on network 100. Merchant app 1104, for example, may query to see if the user is checked into any of the merchant's stores. Similarly merchant app 1104 may query for past receipts of the currently logged-in user.

Callable API 1105 can also be used to change the user's state on network 100. Merchant app 1104 may, for example, use these APIs to let the user clip a new offer from the merchant application or to let the user enable/disable an already clipped coupon. Calls to callable API 1105 in one embodiment result in network requests from mobile SDK 1100 to network 100 as no state is cached in SDK 1100.

Delegate interface 1106 lets SDK 1100 callback into merchant application 1104 with the intent of sharing event notifications. Merchant application 1104 may implement a delegate to receive these event callbacks and register the delegate with SDK 1100. If merchant application 1104 does not register a delegate, events are not explicitly communicated via callback to merchant application 1104.

SDK 1100 in one embodiment includes check-in logic and the ability to receive push notifications 1122 from a host/host application. If merchant application 1104 has registered a delegate it is notified of these events via delegate interface 1106. This interface will most frequently be used to notify the merchant application of changes such as a check-in, or to the availability of new user objects such as a receipt, a new offer or new item.

Callbacks originating from SDK 1100 in one embodiment are the consequence of state changes on network 100 that delegate interface 1106 is propagating back to merchant application 1104. As with callable API 1105, no state/event log is cached in SDK 1100 for delegate events in one embodiment.

Model interface 1107 allows merchant application 1104 to listen to a persistent model representation of the user's state on network 100. Using model interface 1107, merchant application 1104 can observe the current state of the user account and listen for any changes in state. Model interface 1107 combines aspects of callable API 1105 and delegate interface 1106 with an observable local model 1110 that caches a representation of the user account.

Merchant application 1104 and mobile SDK 1100 cooperate with regard to the use of shared OS resources, in particular location services 1124 and push notifications 1122. Specifically, mobile SDK 1100 powers the geo-fencing service that is used to check-in users to make purchases. On iOS and Android, merchant application 1104 asks for permission for background location updates. Mobile SDK 1100 will listen for OS level location updates itself. Upon initialization, mobile SDK 1100 will check the location authorization status of merchant application 1104 to confirm that it is able to receive location updates and export an error via the status vector if merchant application 1104 does not have the appropriate permissions.

In one embodiment, mobile SDK 1100 requires that merchant application 1104 both register for push notification and share incoming notifications with SDK 1100. The SDK callable API (discussed below) has a special routine for handling incoming notifications. Merchant application 1104 should share incoming notifications with SDK 1100 which will either consume the notification if it is a mobile commerce application notification or be a No Operation (“NOP”) if it is a host notification not related to network 100.

During the initialization process, mobile SDK 1100 will request a push notification from network 100 to validate that it is correctly integrated. If it does not receive a push from network 100, SDK 1100 will surface an error via the status vector.

In one embodiment, merchant application 1104 must authenticate itself to SDK 1100 so that SDK 1100 can act on behalf of merchant application 1104. Network 100 may distribute a shared secret that merchant application 1104 can use to authenticate itself to SDK 1100. This authentication only needs to occur once for the lifetime of a given shared secret. If merchant application 1104 authentication fails SDK 1100 will export an error status.

Once authenticated, SDK 1100 performs an internal initialization sequence in which it will register with network 100 to receive push notifications. SDK 1100 will then be ready to receive notification of status changes and interesting events such as new purchases. At this point SDK 1100 will be able to perform a variety of actions on network 100 on behalf of merchant application 1104.

In one embodiment, the user must authenticate via SDK 1100 so that SDK 1100 can access the user's account on network 100, access data (e.g., receipts) and enable the user to complete transactions. User authentication will typically be facilitated in merchant application 1104 by the input username and password. If the mobile commerce application is already installed on a mobile device, a cross application handshake will be used to provide instant personalization. In this scenario SDK 1100 will hand out a derived authentication token that authenticates the user in merchant application 1104 without requiring the input of a username and password. SDK 1100 checks for the presence of the mobile commerce application on the mobile device during initialization and will automatically initiate instant personalization if the mobile commerce application is found.

A transaction from the perspective of a host application can be described as follows. Merchant application 1104 is notified by SDK 1100 through delegate interface 1106 as the user moves through the state transitions of a transaction and can simply respond in a reactive way with its own custom behavior as the user checks in/out of stores or completes a transaction. As the user enters the geo-fence for a store location, SDK 1100 actively monitors the user's location and automatically sends a check-in request to network 100. Upon confirmation of a successful check-in, SDK 1100 exports a check-in update to merchant application 1104 via delegate interface 1100 for check-in updates. At this point the user is ready to pay.

After the user checks out and the basket is communicated to network 100 by POS client 120 using the beanstalk API, network 100 sends a push notification to merchant application 1104. Upon receipt of the push notification, merchant application 1104 will pass the notification to SDK 1100 which will identify network 100 as the originating source and sync the new transaction receipt. Finally, SDK 1100 will export the new receipt to merchant application 1104 via delegate interface 1106 for new receipts.

FIG. 12 is a flow diagram of the functionality of mobile SDK 1100 of FIG. 11 when providing mobile commerce and conducting mobile transactions in accordance with one embodiment.

At 1202, the user enters a geo-fence for a store location, and SDK 1100 monitors the user location and sends a check-in request to network 100.

At 1204, SDK 1100 exports a check-in update to merchant application 1104 via delegate interface 1106 for check-in updates. The check-in updates also fires a notification to push marketing promotions in addition to location awareness. In one embodiment, the user can then optionally activate, delete or save an incentive for later. This is triggered within merchant application 1104, which then seeks approval for the action via SDK 1100 and then returns the result back to merchant application 1104. The result is then exported to the merchant host application (i.e., the Macy's host application).

At 1206, after the user checks out and the basket is communicated to network 100 by POS client 120 using the beanstalk API, network 100 sends a push notification to merchant application 1104. The push notification is received by SDK 1100 from merchant application 1104. The push notification identifies network 100 as the originating source and syncs the new transaction receipt. In one embodiment, SDK 1100 will load the receipt before it pushes it back/exports it to merchant application 1104.

At 1208, SDK 1100 exports the new receipt to merchant application 1104 via delegate interface 1106 for new receipts.

### POS Integration

As disclosed above in conjunction with FIG. 6, network 100 in one embodiment integrates directly into the merchant's POS system/client 120 so that it can include line-level data as part of transaction processing.

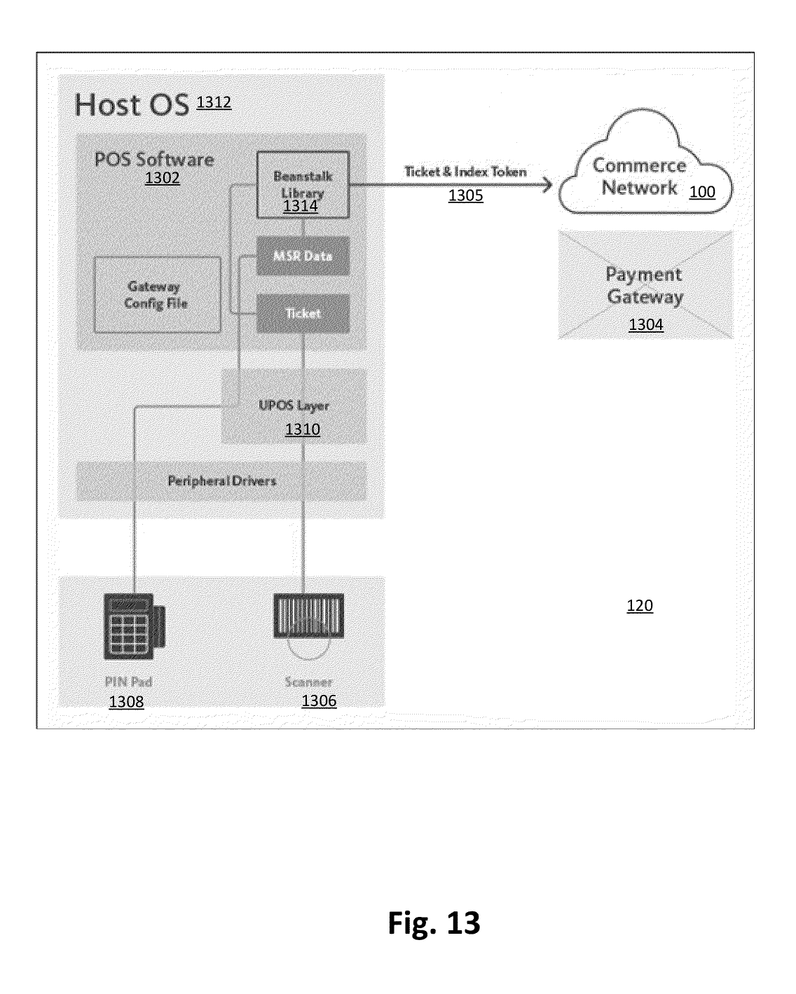

FIG. 13 is a block diagram of POS 120 in accordance with one embodiment. The POS environment of network 100 in accordance with one embodiment includes the following:
POS SW 1302—The software (“SW”) which facilitates the building of a ticket/basket, collection of tender and the initiation of payment processing.
Payment Gateway 1304—a network endpoint to which the POS SW sends tender to facilitate payment in the prior art. This is often a direct connection to the acquirer.
Peripheral Devices—used to collect input data necessary for the transaction (e.g., a barcode scanner 1306, PIN Pad 1308, or receipt printer).
UnifiedPOS (“UPOS”) Layer 1310—a device abstraction layer used to simplify device handling for POS SW. This abstraction layer is broadly used but the coverage is inconsistent as not all devices are well supported.
Host OS 1312—the OS on which the POS SW runs, typically Windows or Linux, the OS is responsible for managing the raw devices.
Sandbox—the runtime environment that the POS SW runs inside/on top of, including the host OS, UPOS, and the upstream payment gateway.
ERP SW—enterprise resource planning (“ERP”) SW. Most major retailers typically use this software on their backend to track inventory and link it to logistics.
TLOG—transaction log, a log of all transactions for a given POS system. There is typically a TLog file per point of sale. Retailers usually use these log files to audit and confirm financial correctness.

For a prior art typical POS transaction, items are scanned/input using a peripheral device. The scanned/input item data flows through a host OS into a UPOS layer and up to a POS SW layer where it is added to the ticket (i.e., the basket of items, taxes and total). After some number of items are scanned the cashier finalizes the transaction and the user is prompted to pay. The user can make the payment while the cashier is still ringing up items.

The user inputs their payment credentials into the card reader, and from there they flow through the UPOS layer into the POS SW. The POS SW then initiates payment processing by sending the basket total and payment credentials to a remote payment gateway. The location of the remote payment gateway is configured in the POS SW such that the POS SW understands how to communicate with the remote payment gateway.

In contrast, in one embodiment, in order to integrate POS 120 with network 100, a beanstalk library/SDK 1314 is integrated directly into the merchant's POS SW 1302. The merchant's POS is configured to use the beanstalk SDK to settle transactions instead of the traditional payment gateway. I/O works as usual as items are scanned/inputed using a peripheral device and the data flows into the POS SW. The POS SW interacts directly with the beanstalk SDK to actively build a ticket such that the state of the ticket is known by the beanstalk SDK.

When the ticket is complete and ready for purchase, the cashier will prompt the consumer to input payment information. The payment/authentication information will flow from the card reader through the UPOS layer and into the POS SW as usual. Once the POS SW has collected payment/authentication information it will tell the beanstalk SDK to initiate the purchase.

In the case of a mobile commerce transaction in accordance with embodiments, the collected information will be a PIN number that the beanstalk SDK will use to authenticate the user to network 100. Once the user is authenticated, the Beanstalk SDK uses the authenticated token and ticket to initiate a transaction on network 100. The beanstalk SDK sends the line-level data, the total and the authentication token to network 100 for processing at 1305.

Network 100 supports the notion of linking cards to a mobile commerce account. This feature lets users capture transaction history, receive email receipts and even redeem offers using their existing plastic cards. For these transactions, the payment information is collected from the card reader. The POS SW will request that the beanstalk SDK initiate a transaction using this info to lookup the Index account and complete the transaction.

The need to directly integrate to the POS presents a potential challenge for merchants who want to leverage the benefits of network 100. Some merchants may be running POS software that is too old to practically update and integrate into network 100. Other merchants may be engaged with POS vendors who are hostile to such an integration for strategic reasons.

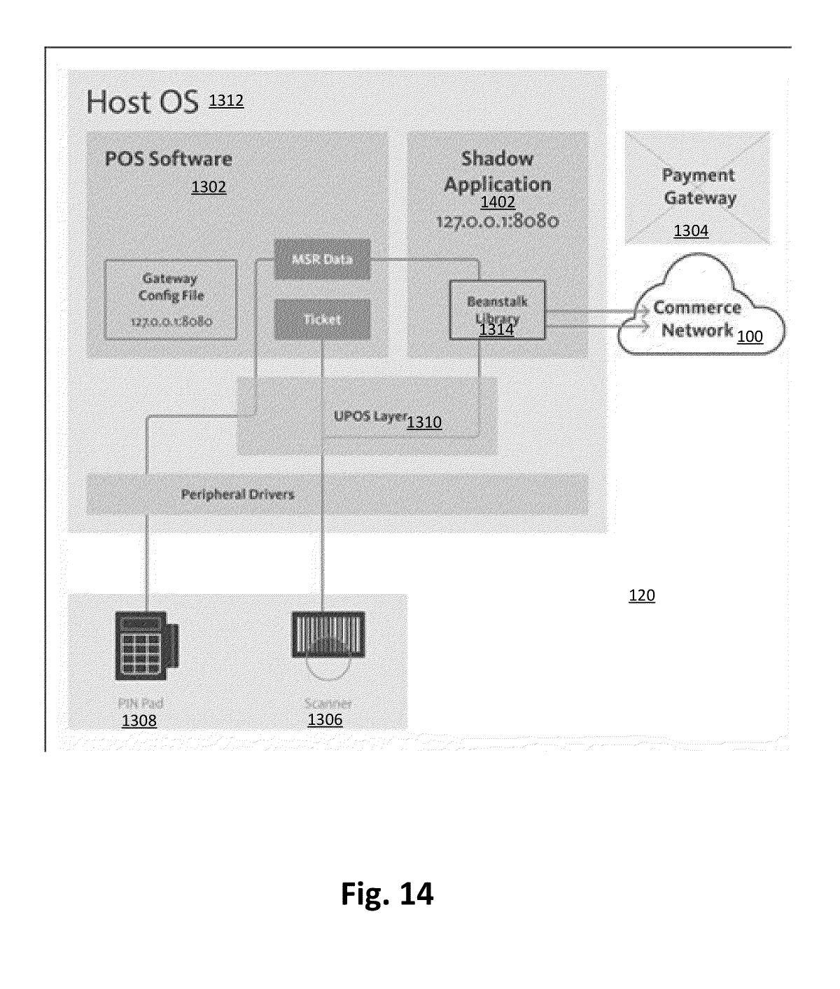

In response, one embodiment incorporates “shadow” POS integration that uses virtualization and sandboxing techniques to leave the existing POS system as is, while still enabling network 100. FIG. 14 is a block diagram of POS 120 in accordance with one embodiment that incorporates shadow integration when beanstalk library/SDK 1314 cannot be directly integrated into POS SW 1302. The shadow integration can have no dependencies on the POS SW in one embodiment. In one embodiment, the beanstalk SDK is wrapped up in a shadow application 1402 that is installed as a companion application to the POS SW. Shadow application 1402 has the same access to the systems resources as the existing POS SW.

In this integration embodiment, the payment gateway configuration for the POS SW is also changed to point to shadow application 1402. When the POS SW initiates any transaction, the transaction is sent to shadow application 1402 on the same system. Using this mechanism, shadow application 1402 intercepts the transaction and handles/completes it as it sees fit.

To facilitate data access for network 100, shadow application 1402 registers itself to receive all I/O from the UPOS layer. This ensures that shadow application 1402 receives any incoming data that will be received by the POS SW. When a barcode is scanned it makes its way through the UPOS layer which relays the data to both the existing POS SW and shadow application 1402.

Shadow application 1402 captures all input data on its own and constructs a ticket without any explicit instruction from the POS SW. The ticket that the shadow application constructs is a shadow of the ticket being constructed by the POS SW. Once the ticket is complete and the consumer is ready to check out, the POS SW will prompt the user to input authentication/payment information.

Since the POS SW does not explicitly understand data from network 100, it does not know how to collect mobile commerce related PIN. Therefore, in one embodiment, the card reader will be modified to collect a mobile commerce related PIN and couple it with a fake invalid card number. The fake card number and PIN will be sent to the POS SW as if it was a normal PIN Debit transaction.

Once the POS SW has collected the fake card number and PIN, it will initiate a transaction by sending the payment information to the payment gateway. Since the POS is configured to think shadow application 1402 is the payment gateway, this payment information will first be sent to shadow application 1402. Shadow application 1402 will recognize the fake card number and know to treat the PIN as an mobile commerce related PIN and complete the transaction as usual.

In the case of an card-based transaction, the user will input card information as usual. When the POS SW initiates a transaction it will go to the shadow application 1402 by virtue of the POS SW being configured to think the shadow application 1402 is the payment gateway. Shadow application 1402 will embed the payment credentials in its own ticket, verify that the total of the shadow ticket is accurate and initiate a transaction on network 100.

Embodiments disclosed above involve mirroring the POS SWs internal state by snooping the barcode scanner. In some situations, peripherals other than the barcode scanner are used to add items to a basket or specify a quantity, for example:
Typing a UPC code into keyboard (bypassing the scanner, perhaps for a blurred barcode).
Scanning a single item and separately indicating a quantity.
Entering a produce/bulk code and then weighing the item (the weight becomes the unit count).

To ease debugging and implementation the shadow application supports a “catch all” mode in one embodiment where all POS inputs are recorded. If the shadow POS then noticed it had an incorrect notion of what the total should be, all the recorded all inputs would be sent to commerce network 100 with the transaction so that operators could figure out what went wrong and even fix the receipt after the fact.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A mobile software development kit (“SDK”) adapted to be executed on a mobile device, the SDK comprising:
a first interface to a host application; and
a second interface to a merchant application executing on the mobile device;
wherein the mobile SDK receives from the host application a check-in of the mobile device to a merchant, and an availability of new user objects, and provides the check-in and new user objects to the merchant application.

2. The mobile SDK of claim 1, wherein the new user objects comprise at least one of a receipt from a purchase at the merchant, a new offer or a new item, wherein the receipt comprises a line item of the purchase.

3. The mobile SDK of claim 1, further comprising:
a model; and
a third interface from the model to the merchant application;
wherein the model stores a current state of a user account associated with the mobile device.

4. The mobile SDK of claim 1, wherein the mobile SDK receives, from the host application, location services of the mobile device and provides the location services to the merchant application.

5. The mobile SDK of claim 4, wherein the location services comprise store information, advertisements, or offers associated with the merchant.

6. A computer readable medium having instructions stored thereon that, when executed by a processor, cause the processor to function as a mobile software development kit (SDK) for a mobile device in communication with a commerce network, the mobile SDK comprising:
a callable application program interface (API) from a merchant application executing on the mobile device; and
a host interface to a host application executing on the commerce network;
wherein the mobile SDK receives from the host application a check-in of the mobile device to a merchant, and an availability of new user objects, and provides the check-in and new user objects to the merchant application.

7. The computer readable medium of claim 6, wherein in response to a user of the mobile device entering a geo-fence of a store location, the mobile SDK monitors a location of the user and sends a check-in request to the commerce network.

8. The computer readable medium of claim 7, further comprising a delegate interface from the mobile SDK to the merchant application, wherein the mobile SDK exports a check-in update to the merchant application using the delegate interface.

9. The computer readable medium of claim 8, further comprising the mobile SDK receiving a push notification from the merchant application, the push notification comprising line item data in response to the user checking out from a retail purchase, the push notification comprising a transaction receipt for the retail purchase.

10. The computer readable medium of claim 9, the mobile SDK further comprising exporting the transaction receipt to the merchant application using the delegate interface.
